(19) United States
(12) Patent Application Publication
(10) Pub. No.: US 2026/0005918 A1
(43) Pub. Date: Jan. 1, 2026

(54) INTERNET OF THINGS (IOT) SYSTEMS AND METHODS FOR SMART GAS PIPELINE NETWORK FAULT SAFETY HANDLING

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Xueqiang LEI, Chengdu (CN); Feng WANG, Chengdu (CN); Guanghua HUANG, Chengdu (CN)

(73) Assignee: CHENGDU QINCHUAN IOT TECHNOLOGY CO., LTD., Chengdu (CN)

(21) Appl. No.: 19/317,113

(22) Filed: Sep. 2, 2025

(30) Foreign Application Priority Data
Jul. 21, 2025 (CN) 202510998361.8

(51) Int. Cl. H04L 41/0659; G16Y 10/35; G16Y 40/10; G16Y 40/35; G16Y 40/40; G16Y 40/50; H04L 67/12

(52) U.S. Cl. CPC H04L 41/0661; G16Y 10/35; G16Y 40/10; G16Y 40/35; G16Y 40/40; G16Y 40/50; H04L 67/12

(57) ABSTRACT

An IoT system and a method for smart gas pipeline network fault safety handling are provided. The method includes: in a first preset period: obtaining platform fault data within the first preset period; for platform fault data of which a fault type is unknown type: in response to determining that a data volume is greater than a preset volume, determining a gas adjustment parameter and sending the gas adjustment parameter to a gas regulation device; in response to determining that the data volume is less than the preset volume: determining a fault handling parameter based on the platform fault data within the first preset period; generating an adjustment instruction based on the fault handling parameter, and sending the adjustment instruction to monitoring devices, a target platform, and/or a personnel interaction device.

### CROSS-REFERENCE TO RELATED APPLICATION

This application claims priority of Chinese Application No. 202510998361.8, filed on Jul. 21, 2025, the entire contents of which are hereby incorporated by reference.

### TECHNICAL FIELD

The present invention relates to the field of pipeline network fault safety handling, and in particular, to an internet of Things (IOT) system and a method for smart gas pipeline network fault safety handling.

### BACKGROUND

With the in-depth advancement of smart city construction, the smart gas system, as a key component of urban infrastructure, is crucial for ensuring the safety and efficiency of urban gas supply. However, in actual operation, smart gas systems may encounter various faults. When a smart gas system fails, how to identify the cause of the fault and how to handle the fault are important issues that need to be resolved.

Therefore, it is necessary to provide an Internet of Things (IOT) system and a method for smart gas pipeline network fault safety handling, which may automatically monitor and effectively diagnose platform faults of the smart gas system, achieve rapid localization and handling of the platform faults, and ensure the safe operation of the gas pipeline network.

### SUMMARY

One or more embodiments of the present disclosure provide an Internet of things (IoT) system for smart gas pipeline network fault safety handling. The IT system comprises: a government safety supervision service platform; a government safety supervision management platform; a government safety supervision sensing network platform; a government safety supervision object platform; a gas company sensing network platform; a smart gas device object platform; and a gas maintenance object platform. The government safety supervision object platform includes a gas company management platform and key gas-consuming enterprises. The smart gas device object platform at least includes monitoring devices and a gas regulation device deployed in a gas pipeline network. The monitoring devices are configured to monitor the gas pipeline network. The gas maintenance object platform at least includes personnel interaction devices. The government safety supervision management platform is configured to execute the method for smart gas pipeline network fault safety handling.

One or more embodiments of the present disclosure provide a method for smart gas pipeline network fault safety handling. The method is executed by the government safety supervision management platform in the IoT system for smart gas pipeline network fault safety handling. The method comprises: in a first preset period: obtaining platform fault data within the first preset period, wherein the platform fault data includes a faulty platform and/or a fault type occurring on the faulty platform; for platform fault data of which the fault type is unknown type: in response to determining that a data volume is greater than a preset volume, determining a gas adjustment parameter and sending the gas adjustment parameter to the gas regulation device; in response to determining that the data volume is less than the preset volume: determining a fault handling parameter based on the platform fault data within the first preset period; generating an adjustment instruction based on the fault handling parameter, and sending the adjustment instruction to one or more of the monitoring devices to adjust monitoring parameters of the one or more of the monitoring devices, and/or sending the adjustment instruction to one or more target platforms to adjust communication parameters of the one or more target platforms, and/or sending the adjustment instruction to the personnel interaction devices to adjust on-site personnel arrangement; wherein, the first preset period includes one or more second preset periods; the obtaining the platform fault data within the first preset period includes: periodically obtaining the platform fault data during the one or more second preset periods within the first preset period according to the one or more second preset periods; in each of the one or more second preset periods: obtaining communication features of the one or more target platforms; obtaining monitoring data of the monitoring devices; and determining the platform fault data based on the communication features and the monitoring data.

One or more embodiments of the present disclosure provide a non-transitory computer-readable storage medium. The storage medium stores computer instructions. When the computer instructions are executed by a computer, the method for smart gas pipeline network fault safety handling is implemented.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an exemplary platform structure of an Internet of things (IoT) system for smart gas pipeline network fault safety handling according to some embodiments of the present disclosure;

FIG. 2 is a flowchart illustrating an exemplary process of a method for smart gas pipeline network fault safety handling according to some embodiments of the present disclosure;

FIG. 3 is an exemplary schematic diagram of determining platform fault data according to some embodiments of the present disclosure; and

FIG. 4 is an exemplary schematic diagram of determining a fault handling parameter according to some embodiments of the present disclosure.

### DETAILED DESCRIPTION

The accompanying drawings, which are required to be used in the description of the embodiments, are briefly described below. The accompanying drawings do not represent the entirety of the embodiments. When describing operations performed step-by-step in the embodiments of the present disclosure, unless otherwise specified, the order of the operations may be adjusted, operations may be omitted, and additional steps may be included in the processes.

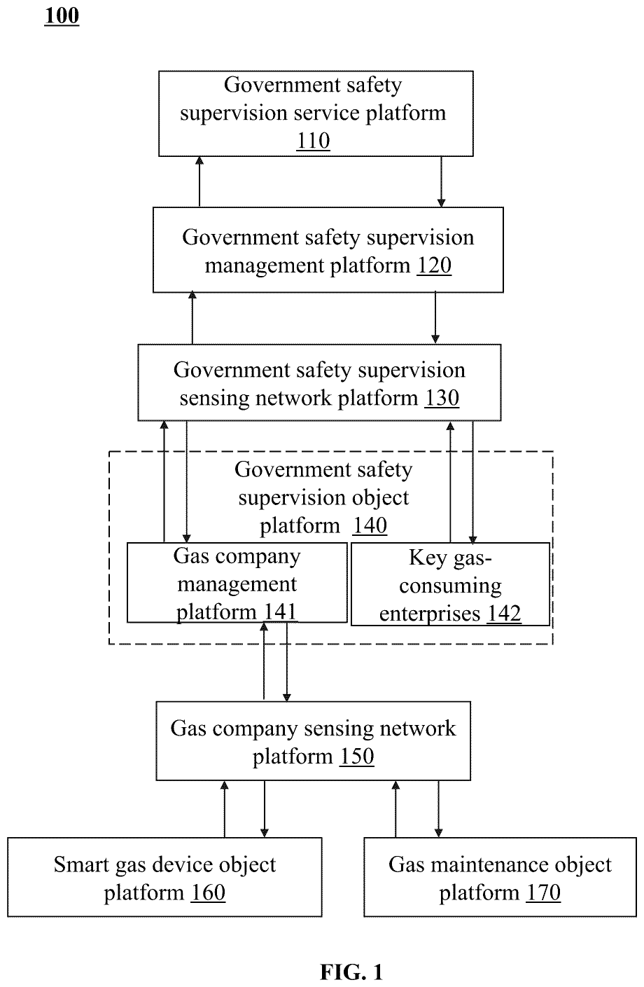

FIG. 1 is a schematic diagram illustrating an exemplary platform structure of an Internet of things (IoT) system for smart gas pipeline network fault safety handling according to some embodiments of the present disclosure.

In some embodiments, as shown in FIG. 1, an IoT system 100 for smart gas pipeline network fault safety handling may include a government safety supervision service platform 110, a government safety supervision management platform 120, a government safety supervision sensing network platform 130, a government safety supervision object platform 140, a gas company management platform 141, key gas-consuming enterprises 142, a gas company sensing network platform 150, a smart gas device object platform 160, and a gas maintenance object platform 170.

The government safety supervision service platform 110 refers to a platform that provides supervision services for the government and may be configured as a server.

The government safety supervision management platform 120 refers to a platform for the government to conduct safety supervision and management, and may be configured as a processor and/or server and memory. The processor may process data and/or information related to the IoT system 100 for smart gas pipeline network fault safety handling. Merely by way of example, the processor may be a Central Processing Unit (CPU), an Application-Specific Integrated Circuit (ASIC), etc.

In some embodiments, the processor may interact with a plurality of platforms included in the IoT system 100 for smart gas pipeline network fault safety handling, or may be configured in a plurality of platforms.

In some embodiments, the government safety supervision management platform 120 may perform data interaction upward with the government safety supervision service platform 110, and downward, perform data interaction with the government safety supervision object platform 140 through the government safety supervision sensing network platform 130.

In some embodiments, the government safety supervision management platform 120 is configured to execute the method for smart gas pipeline network fault safety handling.

The government safety supervision sensing network platform 130 refers to a platform used by the government for supervising and managing sensing network information and may be configured as communication device and gateways.

In some embodiments, the government safety supervision sensing network platform 130 may be configured to facilitate communication between the government safety supervision management platform 120 and the government safety supervision object platform 140.

The government safety supervision object platform 140 refers to an object platform for generating perception information and executing control information.

In some embodiments, the government safety supervision object platform 140 may include the gas company management platform 141 and the key gas-consuming enterprises 142.

The gas company management platform 141 refers to a comprehensive management platform for relevant information of a gas company and may be configured as a processor and/or server and memory.

The key gas-consuming enterprises 142 refer to relevant enterprises that require special attention to their gas usage, e.g., chemical plants that use large amounts of gas, etc.

The gas company sensing network platform 150 refers to a comprehensive management platform for sensing information of a gas company and may be configured as a communication network, a gateway, etc.

In some embodiments, the gas company sensing network platform 150 may be configured to facilitate communication between the government safety supervision object platform 140, and the smart gas device object platform 160 and the gas maintenance object platform 170.

The smart gas device object platform 160 refers to a functional platform for real-time monitoring and intelligent regulation of the gas pipeline network. In some embodiments, the smart gas device object platform 160 at least includes monitoring devices and a gas regulation device deployed in the gas pipeline network.

In some embodiments, the smart gas device object platform 160 may perform data interaction with the gas company management platform 141 through the gas company sensing network platform 150.

The monitoring device refers to relevant device configured to monitoring and recording the operating status of the gas pipeline network.

In some embodiments, the monitoring device is configured to monitor the gas pipeline network, e.g., a pressure sensor is configured to monitor the gas pressure inside the pipeline, a temperature sensor is configured to monitor the temperature changes of the gas inside the pipeline and the surrounding environment of the pipeline, a flow sensor is configured to monitor the gas flow inside the pipeline, etc.

The gas regulation device refers to relevant device configured to controlling and regulating the gas in the pipeline, e.g., valves used to shut down gas transportation in gas pipelines, pressure regulators used to reduce or enhance the gas pressure inside the pipeline, etc.

The gas maintenance object platform 170 refers to a platform for interacting with gas workers. The gas workers refer to personnel engaged in work related to the gas pipeline network, e.g., safety officers, maintenance workers, storage and transportation workers, etc.

In some embodiments, the gas maintenance object platform 170 at least includes personnel interaction devices.

The personnel interaction devices refer to devices for interacting with the gas workers. For example, the personnel interaction devices may includes mobile phones, computers, etc. In some embodiments, the personnel interaction devices may receive an adjustment instruction issued by the government safety supervision management platform 120 to adjust on-site personnel arrangement.

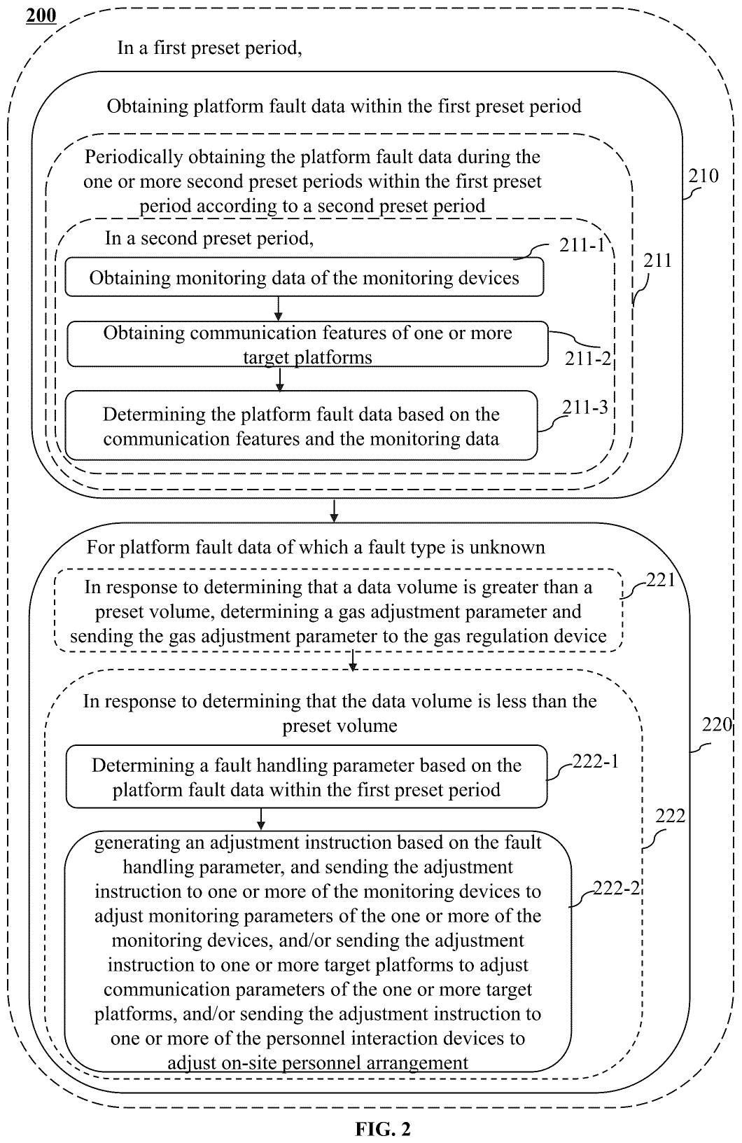

For more details about the above platforms, refer to FIGS. 2-4 and their related descriptions.

In some embodiments of the present disclosure, based on the IoT system 100 for smart gas pipeline network fault safety handling, an information operation closed loop can be formed among various functional platforms. Coordinated and regular operation under the unified management of the government safety supervision management platform achieves informatization and intellectualization of smart gas pipeline network fault safety handling.

It should be noted that the above description of the IoT system for smart gas pipeline network fault safety handling and its platforms is for descriptive convenience only and does not limit the present disclosure to the scope of the cited embodiments. It is understood that for those skilled in the art, after understanding the principles of the system, they may arbitrarily combine various platforms or form subsystems connected to other platforms without departing from this principle.

FIG. 2 is a flowchart illustrating an exemplary process of a method for smart gas pipeline network fault safety handling according to some embodiments of the present disclosure. In some embodiments, a process 200 may be executed by the government safety supervision management platform 120. For example, the process 200 may be executed by a processor in the government safety supervision management platform 120.

In some embodiments, as shown in FIG. 2, the processor may execute the following steps 210-220 in a first preset period.
Step 210, obtaining platform fault data within the first preset period.

The first preset period is a preset period from the start of obtaining the platform fault data to determining a fault handling parameter. In some embodiments, the first preset period may be set by the processor by default or by a technician based on historical experience, e.g., as 6 hours before a current time.

In some embodiments, for the platform fault data within one first preset period, the processor may process them together in the same batch.

The platform fault data refers to data related to the fault situation of platforms in the IoT system for smart gas pipeline network fault safety handling. In some embodiments, the platform fault data may include a faulty platform and/or a fault type occurring on the faulty platform.

The faulty platform refers to a platform in the IoT system for smart gas pipeline network fault safety handling that has failed. In some embodiments, for a platform in the IoT system, if it is unable to perform its predetermined functions or services normally, it is determined to be the faulty platform.

The fault type refers to a type of fault occurring on the faulty platform. In some embodiments, the fault type may include storage, forwarding, computing, and unknown.

A storage type fault refers to a fault related to data storage, e.g., the platform is unable to write data or read data.

A forwarding type fault refers to a fault related to data transmission, e.g., data loss or transmission delay occurs when the platform is transmitting data.

A computing type fault refers to a fault related to data processing or analysis, e.g., incorrect calculation results computed by the platform or decreased processing speed.

An unknown type fault refers to a fault whose specific cause is unable to be determined and requires further diagnosis and analysis. For example, the abnormal reading of a certain key parameter or a stop in updating, but preliminary inspection is unable to determine the specific cause of the fault.

In some embodiments, step 210 may further include step 211. The processor may execute step 211 to obtain the platform fault data within the first preset period.
Step 211, periodically obtain the platform fault data during one or more second preset periods within the first preset period according to the one or more second preset periods.

The second preset period refers to a preset period for obtaining the platform fault data. Within one second preset period, the processor may perform one determination of the faulty platform and the fault type.

In some embodiments, the first preset period may include the one or more second preset periods. The processor may periodically obtain the platform fault data according to the second preset period, that is, collect the platform fault data once per second preset period. For the platform fault data within the one or more second preset periods in one first preset period, the processor may process them together in the same batch to determine the fault handling parameter.

In some embodiments, the second preset period may be set by the processor by default or by a technician based on historical experience, such as 1 hour, etc.

The fault handling parameter refers to a relevant parameter for fault handling. In some embodiments, the fault handling parameter may include gas adjustment parameters of one or more gas regulation devices.

In some embodiments, a period length of the first preset period is related to a fault response speed, and a period length of the second preset period is related to a complexity level of the gas pipeline network.

The fault response speed refers to a speed of responding to and handling the fault. In some embodiments, the processor may calculate an average value of a plurality of fault handling times corresponding to a plurality of historical fault handling processes and determine it as the fault response speed.

The faster the fault response speed, the shorter an average time required to resolve the fault. Therefore, the first preset period may be appropriately extended to obtain more platform fault data, allowing more faults to be processed in the same batch and improving fault handling efficiency.

In some embodiments, the complexity level of the gas pipeline network may be characterized by a count of pipeline intersection nodes and a count of devices connected by pipelines. The greater the count of pipeline intersection nodes and the count of devices connected by pipelines, the higher the complexity level of the gas pipeline network.

In some embodiments, the period length of the second preset period may be negatively correlated with the complexity level of the gas pipeline network. The higher the complexity level of the gas pipeline network, the greater the difficulty in fault diagnosis and problem tracing. The second preset period may be short to collect the platform fault data at short intervals, facilitating rapid identification of abnormal data and tracing the source of the problem.

In some embodiments of the present disclosure, the faster the fault response speed, the shorter a length of the average time required to resolve the fault. By extending the first preset period, more faults can be processed in the same batch within the same period, thereby improving processing efficiency. The higher the complexity level of the gas pipeline network, the greater the difficulty in fault tracing. By shortening the second preset period, the abnormal data can be quickly discovered, improving the system's risk response capability.

In some embodiments, the step 211 may further include step 211-1, step 211-2, and step 211-3. The processor may execute step 211-1, step 211-2, and step 211-3 in the second preset period to obtain the platform fault data within the second preset period.
Step 211-1, obtaining monitoring data of the monitoring devices.

More details about the monitoring devices may be found in FIG. 1 and related descriptions.

The monitoring data refers to data collected by the monitoring devices during a monitoring process. In some embodiments, the monitoring data may include a monitoring object and monitoring content of the monitoring object.

The monitoring object refers to a target monitored by the monitoring device, e.g., an internal temperature of a gas pipeline 1.

The monitoring content refers to data actually monitored by the monitoring device for the monitoring object. For example, if the monitoring object is the internal temperature of the gas pipeline 1, the monitoring content of the monitoring object may be a sequence of the internal temperatures of the gas pipeline 1 at a plurality of time points.

In some embodiments, the processor may obtain the monitoring data from the monitoring device in the smart gas device object platform through the government safety supervision sensing network platform and the gas company sensing network platform.
Step 211-2, obtaining communication features of one or more target platforms.

The target platform refers to a platform for which communication features need to be obtained. The target platform may include the government safety supervision service platform, the government safety supervision management platform, the government safety supervision sensing network platform, the government safety supervision object platform, the gas company sensing network platform, the smart gas device object platform, and the gas maintenance object platform.

The communication features refer to relevant features of communication data of the platform. The communication data refers to data transmitted during communication between platforms.

In some embodiments, the communication data of the target platform may be the monitoring data processed by the target platform, that is, the platform fault data is determined by transmitting the monitoring data between the target platforms.

In some embodiments, the communication features may include a data type, a data traffic, a data transmission/reception time, a transmission priority, and a data source platform of the communication data. That is, the communication features of the target platform may include the data type, the data traffic, the data transmission/reception time, the transmission priority, and the data source platform of the monitoring data processed by the target platform.

The data type refers to a nature or category of the communication data. In some embodiments, the data type may include storage type data, computing type data, and forwarding type data.

The storage type data refers to data that will ultimately be stored on the target platform. The computing type data refers to data that is processed and manipulated on the target platform. The forwarding type data refers to data that is only transmitted through the target platform and is not stored or computed on the target platform. In some embodiments, the processor may determine the data type by analyzing a processing manner, a transmission path, and a role in the system of the communication data.

The data traffic refers to a total amount of data transmitted per unit time, such as 100 Mbps. The data traffic may be used to measure a data transmission rate. For example, In some embodiments, the processor may use network monitoring tools to capture and analyze data transmission on network interfaces to obtain data traffic.

The data transmission/reception time refers to a time difference between a time when the target platform starts receiving and a time when the target platform sending the communication data, i.e., a time interval between data flowing into the platform and flowing out of the platform. Specifically, if the target platform serves as an endpoint platform for data inflow, meaning it only receives data without sending data out, the data transmission/reception time may be represented by the time interval from the first data byte flowing into the platform to the last data byte flowing into the platform. If the target platform serves as an initial platform for data outflow, meaning it only sends data without receiving data, the data transmission/reception time may be represented by the time interval from the first data byte flowing out of the platform to the last data byte flowing out of the platform.

In some embodiments, the processor may determine the data transmission/reception time through timestamps recorded by network monitoring tools or system logs.

The transmission priority refers to a priority level at which the target platform transmits the communication data. The communication data with a higher transmission priority will be transmitted before the communication data with a lower transmission priority.

In some embodiments, the transmission priority may be represented by an integer value between 1 and 10. A higher value indicates the higher transmission priority. In some embodiments, the transmission priority of the data may be set by the processor by default or by technicians based on historical experience.

The data source platform refers to a source platform of the communication data. For example, if the communication data received by the government safety supervision object platform is transmitted from the government safety supervision management platform, then the government safety supervision management platform is the data source platform for the communication data.
Step 211-3, determining the platform fault data based on the communication features and the monitoring data.

In some embodiments, the processor may determine the platform fault data based on the communication features and the monitoring data in various ways.

For example, the processor may determine an expected processing duration by querying historical data based on the data type, the data traffic, and the transmission priority in the communication features; determine a time deviation based on the expected processing duration and the data transmission/reception time; in response to determining that the time deviation is greater than a deviation threshold, determine the target platform to be the faulty platform; and determine the platform fault data based on the data type of the communication data and the data source platform.

The expected processing duration refers to an estimated time duration for the target platform to process the communication data under normal conditions. The expected processing duration may be obtained by the processor based on historical data. For example, for communication data with the data type of storage type data, the data traffic of 100 Mbps, and the transmission priority of 6, the processor may obtain a plurality of pieces of historical communication data identical to it, calculate an average value of a plurality of historical actual processing durations corresponding to these historical communication data, and determine the average value as the expected processing duration corresponding to that communication data.

The time deviation refers to a difference between the actual processing time and the expected processing duration. The time deviation may be used to measure the efficiency of the system in processing the communication data.

In some embodiments, the processor may determine a difference obtained by subtracting the data transmission/reception time from the expected processing duration as the time deviation.

The deviation threshold refers to a preset threshold for the time deviation. In some embodiments, the deviation threshold may be related to the transmission priority. The higher the transmission priority, the smaller the deviation threshold.

In some embodiments, in response to determining that the time deviation corresponding to the target platform is greater than the deviation threshold, the target platform is determined to be a candidate faulty platform.

In some embodiments, for a target platform determined to be the candidate faulty platform, if the data type of the communication data of the target platform is storage type data or forwarding type data, the processor may determine the target platform to be a faulty platform, and determine the fault type of the target platform to be storage type fault or forwarding type fault accordingly.

In some embodiments, for a target platform determined to be a candidate faulty platform, if the data type of the communication data of the target platform is computing type data, the processor may obtain the data type of the data processed by the data source platform, and compare the data type corresponding to the target platform with the data type corresponding to the data source platform. In response to determining that the two data types are inconsistent, the processor may determine all platforms through which the communication data flows from the data source platform to the target platform as faulty platforms, and the corresponding fault type for all platforms is the unknown type fault. In response to determining that the two data types are consistent, the processor may determine both the data source platform and the target platform as the faulty platforms, wherein the fault type corresponding to the data source platform is the unknown type fault, and the fault type corresponding to the target platform is the computing type fault.

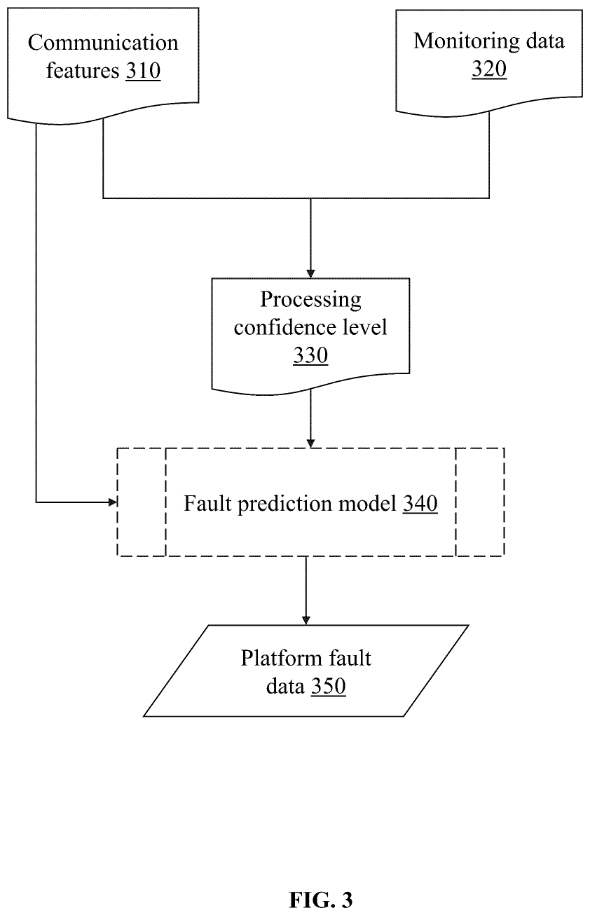

In some embodiments, the processor may further determine a processing confidence level of the target platform based on the communication features and the monitoring data; and determine the platform fault data based on the processing confidence level and the communication features of the target platform. More details about this part may be found in FIG. 3 and related descriptions.

In some embodiments, for platform fault data with a fault type of unknown type, the processor may execute step 220. Step 220 may further include step 221-222.

In some embodiments, for platform fault data of which a fault type is unknown, in response to determining that a data volume is greater than a preset volume, the processor may execute step 221.
Step 221, in response to determining that the data volume is greater than the preset volume, determine a gas adjustment parameter and send the gas adjustment parameter to the gas regulation device.

The data volume refers to a total amount of data marked for processing when the faulty platform fails, that is, the total amount of data involved for a specific fault type. Marking refers to categorizing the fault and recording its fault type. For example, among the data marked by the faulty platform in the first preset period, if 2 GB of platform fault data is marked as the unknown type fault, then the data volume corresponding to the unknown type fault is 2 GB.

The preset volume refers to a maximum amount of fault data that the system or platform is preset to be able to handle quickly. In some embodiments, the preset volume may be determined by the processor based on the disaster recovery capability of the IoT system for smart gas pipeline network fault safety handling. The stronger the disaster recovery capability, the larger the preset volume.

The disaster recovery capability refers to the ability to quickly restore the system and data in the event of a failure to reduce data loss and business interruption.

The gas adjustment parameter refers to a parameter used to adjust the operation of the gas pipeline network. In some embodiments, the gas adjustment parameter may include operating parameters of one or more gas regulation devices, e.g., a valve opening of a gas pressure reducing valve, a flow rate setting of a gas flow meter, a pressure setting of a gas pressure regulator, etc.

In some embodiments, in response to determining that the data volume is greater than the preset volume, the processor may determine the gas adjustment parameter in various ways. For example, the processor may determine the gas adjustment parameter according to a preset plan.

The preset plan refers to a pre-set plan used to reduce system risk. In some embodiments, the preset plan may be evaluated and determined by technicians based on historical experience and reference to historical data. For example, the preset plan may be to shut down some secondary gas pipelines when the data volume exceeds the preset volume.

In some embodiments, the processor may further adaptively adjust the gas adjustment parameter based on the gap between the data volume of the unknown type fault and the preset volume, based on the preset plan. For example, if the preset plan is to reduce the internal pressure of the gas pipeline, when the data volume of the unknown type fault is far greater than the preset volume, the processor may further reduce the internal pressure of the gas pipeline based on the preset plan. The corresponding gas adjustment parameter may include a larger valve opening for the pressure reducing valve of the gas pipeline.

In some embodiments, the government safety supervision management platform may send the gas adjustment parameter to the gas regulation device in the smart gas device object platform through the government safety supervision sensing network platform and the gas company sensing network platform to control the gas regulation device to adjust the operation of the gas pipeline network and reduce overall risk.

In some embodiments, for platform fault data of which a fault type is unknown, in response to determining that the data volume is less than the preset volume, the processor may execute step 222. Step 222 further includes step 222-1 and step 222-2.
Step 222-1, determining the fault handling parameter based on the platform fault data within the first preset period.

In some embodiments, the processor may determine the fault handling parameter based on the platform fault data within the first preset period in various ways. For example, the processor may determine a fault frequency distribution of the faulty platform based on the platform fault data within the first preset period; and determine the fault handling parameter corresponding to the faulty platform based on the fault frequency distribution.

The fault frequency distribution refers to a frequency distribution of different fault types occurring on the faulty platform. In some embodiments, the fault frequency distribution may be represented by the frequency of occurrence of different fault types on the faulty platform within one or more second preset periods of the first preset period. One faulty platform corresponds to one fault frequency distribution. For example, if the first preset period is one day, the second preset period is each hour within that day, and statistics show that faulty platform A experienced 2 storage type faults, 4 computing type faults, 3 forwarding type faults, and 1 unknown type fault within the first preset period, then the fault frequency distribution of the faulty platform A is (2 storage type faults, 4 computing type faults, 3 forwarding type faults, 1 unknown type fault).

In some embodiments, for one faulty platform, the processor may determine a low-probability fault and an other-probability fault of the faulty platform based on the fault frequency distribution; determine a fault to be handled based on the low-probability fault and the other-probability fault; and determine the fault handling parameter based on the fault to be handled.

In some embodiments, the processor may determine an occurrence probability of various faults on the faulty platform based on the fault frequency distribution; in response to determining that a variance of the occurrence probabilities of various faults is less than a variance threshold, determine that there is no low-probability fault on the faulty platform; in response to determining that the variance of the occurrence probabilities of various faults is not less than the variance threshold, determine that there is a low-probability fault on the faulty platform; calculate a probability mean of the occurrence probabilities of various faults; determine a fault with the occurrence probability less than the probability mean as the low-probability fault; and determine a fault that is not a low-probability fault as the other-probability fault. The variance threshold may be set by the processor by default or by a technician based on experience.

For example, if the fault frequency distribution of the faulty platform A is (2 storage type faults, 4 computing type faults, 3 forwarding type faults, 1 unknown type fault), then the occurrence probabilities for the storage type fault, the computing type fault, the forwarding type fault, and the unknown type fault are 0.2, 0.4, 0.3, and 0.1, respectively. The variance of the occurrence probabilities of the 4 fault types is 0.0125. If the variance threshold is 0.02, there is no low-probability fault, meaning all 4 faults are the other-probability faults. If the variance threshold is 0.01, there are low-probability faults. The probability mean of the occurrence probabilities of the 4 faults is 0.25. The occurrence probabilities of the storage type fault and the unknown type fault are both less than the probability mean, so the storage type fault and the unknown type fault are the low-probability faults, while the computing type fault and forwarding type fault are the other-probability faults.

In some embodiments, for one low-probability fault, the processor may determine a last fault time of the low-probability fault, calculate a time difference between the last fault time and the current time, and in response to determining that the time difference is greater than the period length of the second preset period, determine the low-probability fault as a fault to be handled. For the other-probability fault, the processor may directly determine it as the fault to be handled. The last fault time refers to a most recent time the fault occurred. The fault to be handled refers to a fault that needs to be processed. The fault to be handled include the aforementioned low-probability faults where the time difference is greater than the period length of the second preset period, and all other-probability faults.

For example, if the storage type fault is the low-probability fault, the last fault time of the storage type fault is October 14, 08:00, the current time is October 14, 09:30, and the period length of the second preset period is 1 hour, then the time difference between the last fault time and the current time is 1.5 hours, which is greater than the period length of the second preset period. Therefore, the storage type fault is the fault to be handled. If the computing type fault and the forwarding type fault are the other-probability faults, then the faults to be handled include the storage type fault, the computing type fault, and the forwarding type fault.

In some embodiments, in response to determining that the fault to be handled is the storage type fault and/or the forwarding type fault, the processor may determine a fault handling solution by querying a first preset table; and determine the fault handling parameter based on the fault handling solution. The first preset table may include the storage type fault, the forwarding type fault, and the corresponding fault handling solution. The first preset table may be constructed by technicians based on historical data and prior experience.

The fault handling solution refers to a series of predetermined response schemes for various types of faults. For example, if the storage type fault is a failure of a storage device of the faulty platform, the fault handling solution in the first preset table may be to trigger a preset fault handling procedure of the storage device. The preset fault handling procedure of the storage device may include accessing a backup storage medium, enabling a backup storage device, overwriting old data with the latest data, etc. As another example, if the forwarding type fault is a failure of a communication device of the faulty platform, the fault handling solution in the first preset table may be to trigger a preset fault handling procedure of the communication device. The preset fault handling procedure of the communication device may include restoring a default setting of a communication network and restarting the communication device, etc.

In some embodiments, the processor may include the preset fault handling procedure in the fault handling parameter.

In some embodiments, in response to determining that the fault to be handled is the computing type fault and/or the unknown type fault, the processor may determine fault handling personnel by querying a personnel arrangement schedule; and determine the fault handling parameter based on the fault handling personnel. The personnel arrangement schedule may include the computing type fault, the unknown type fault, and the corresponding fault handling personnel. The personnel arrangement schedule may be preset by relevant departments or units.

The fault handling personnel for the computing type fault may be management personnel of the faulty platform. The fault handling personnel for the unknown type fault may be management personnel of the faulty platform and/or the management personnel of the monitoring device.

In some embodiments, in response to determining that the fault to be handled is the computing type fault, the processor may include the management personnel of the faulty platform and the platform fault data of the faulty platform in the fault handling parameter.

In some embodiments, in response to determining that the fault to be handled is the unknown type fault, if it corresponds to the monitoring device experiencing the unknown type fault, the processor may include the management personnel of the monitoring device and a default monitoring parameter in the fault handling parameter; if it corresponds to the faulty platform experiencing the unknown type fault, the processor may include the management personnel of the faulty platform, the platform fault data of the faulty platform, and the default monitoring parameter in the fault handling parameter.

The monitoring parameter refers to an operating parameter of the monitoring device, used to determine how the monitoring device collects, processes, and responds to data, such as an operating mode of the monitoring device, a preset alarm threshold, a data sampling frequency, etc. The default monitoring parameter refers to a standard monitoring parameter adopted by the system when there is no specific configuration or when the unknown type fault occurs.

In some embodiments, for one faulty platform, the processor may synthesize a plurality of fault handling parameters corresponding to all faults to be handled on that faulty platform to determine the fault handling parameter for the faulty platform.

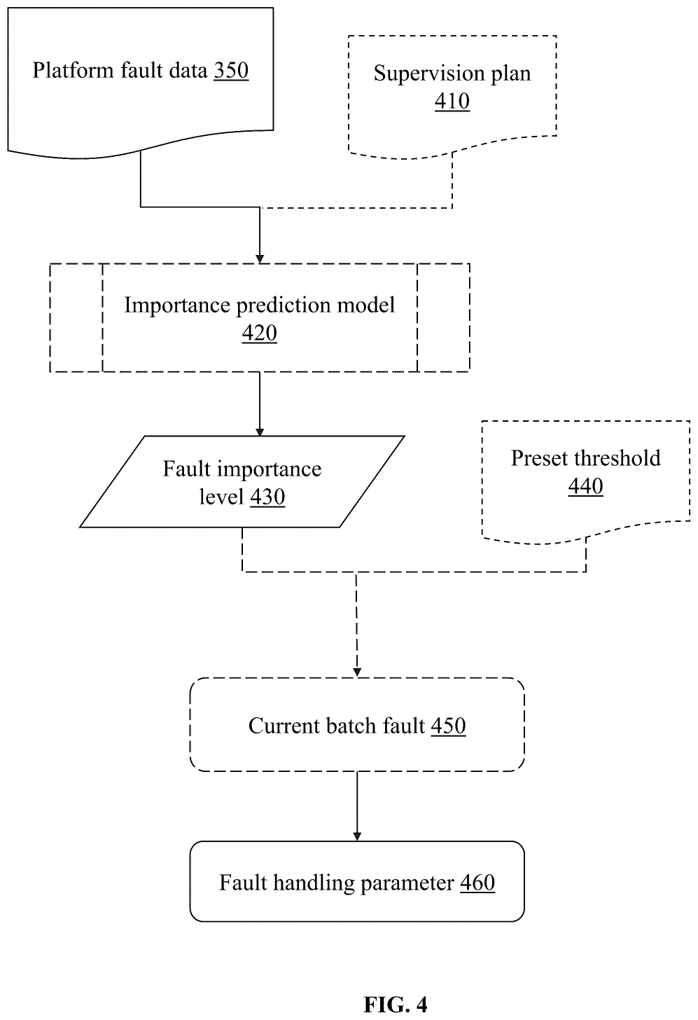

In some embodiments, the processor may determine a fault importance level of the fault based on the platform fault data within the first preset period; and determine the fault handling parameter based on the fault importance level. More details about this part may be found in FIG. 4 and related descriptions.
Step 222-2, generating an adjustment instruction based on the fault handling parameter, and sending the adjustment instruction to one or more of the monitoring devices to adjust the monitoring parameters of the one or more of the monitoring devices, and/or sending the adjustment instruction to one or more target platforms to adjust communication parameters of the one or more target platforms, and/or sending the adjustment instruction to one or more personnel interaction devices to adjust on-site personnel arrangement.

In some embodiments, the adjustment instruction may be configured to guide the monitoring device to adjust the monitoring parameters, guide the target platform to adjust the communication parameters, guide the personnel interaction device to adjust the on-site personnel arrangement, guide other devices to adjust working parameters, etc.

In some embodiments, the adjustment instruction may be determined based on the fault handling parameter. For example, for the storage type fault, if the fault handling parameter is the preset fault handling procedure of the storage device, and the preset fault handling procedure is to enable the backup storage device, then the corresponding adjustment instruction may be to enable the backup storage device. The government safety supervision management platform sends the adjustment instruction to the backup storage device to guide the activation of the backup storage device.

As another example, for the forwarding type fault, if the fault handling parameter is to optimize the transmission path, then the corresponding adjustment instruction may be to adjust network routing settings or encrypt a transmission protocol. The government safety supervision management platform sends the adjustment instruction to relevant communication device to optimize the data transmission process. As another example, for the computing type fault, if the fault handling parameter is the management personnel of the faulty platform and the platform fault data of the faulty platform, then the corresponding adjustment instruction may be to assign the management personnel of the faulty platform. The government safety supervision management platform sends the adjustment instruction to the personnel interaction device to adjust the on-site personnel arrangement.

As another example, for the unknown type fault, if the fault handling parameter is the management personnel of the faulty platform, the platform fault data of the faulty platform, and the default monitoring parameter, then the corresponding adjustment instruction may be to assign the management personnel of the faulty platform and enable the default monitoring parameters. The government safety supervision management platform sends these instructions to the monitoring device or the personnel interaction device to adjust the on-site personnel arrangement and restore the default monitoring parameters.

The communication parameter refers to a working parameter of the communication device, configured to determine how the communication device sends and receives data on the network, e.g., a packet size, a transmission rate, the network protocol, etc.

The on-site personnel arrangement refer to staff responsible for operation and maintenance at the site of the gas pipeline network. In some embodiments, the personnel interaction device may adjust the on-site personnel arrangement according to the adjustment instruction.

In some embodiments of the present disclosure, by obtaining the platform fault data within the second preset period and autonomously determining whether to adjust the gas adjustment parameter based on the size of the fault data volume within the first preset period, the processor can timely adjust the gas regulation device or prepare corresponding fault handling measures. This can effectively avoid subsequent problems in the operation of the gas pipeline network, help improve fault response speed, optimize resource allocation, and enhance the reliability and safety of the entire gas supply network.

It should be noted that the above description regarding the process 200 is for example and illustration only and does not limit the scope of application of the present disclosure. For those skilled in the art, various modifications and changes may be made to the process 200 under the guidance of the present disclosure. However, these modifications and changes still fall within the scope of the present disclosure.

FIG. 3 is an exemplary schematic diagram of determining platform fault data according to some embodiments of the present disclosure.

In some embodiments, the monitoring data may further include data importance. As shown in FIG. 3, the processor may determine a processing confidence level 330 of the one or more target platforms based on communication features 310 and monitoring data 320; and determine platform fault data 350 based on the processing confidence level 330 and the communication features 310 of one or more target platforms.

The data importance refers to an importance level of the monitoring object included in the monitoring data. In some embodiments, the monitoring data may include a monitoring object, monitoring content of the monitoring object, and data importance.

In some embodiments, the data importance may be represented by a value between 0 and 1. A higher value indicates higher data importance.

In some embodiments, the processor may determine the data importance corresponding to the monitoring data by querying a second preset table. The second preset table may include a pipeline area of the monitoring object and the data importance of the monitoring data. The division of the pipeline areas may be preset by technicians based on experience.

For example, if the monitoring object included in monitoring data W₁ is the internal temperature of gas pipeline 1, and the pipeline area of gas pipeline 1 is area C₁, querying the second preset table may determine that the data importance corresponding to the area C₁ is 0.6. Therefore, the data importance of the monitoring data W₁ is 0.6.

More details about the monitoring object and the monitoring content may be found in FIG. 2.

The processing confidence level refers to a degree of conformity between an actual processing result of the platform and an expected processing result. In some embodiments, the processing confidence level may refer to a degree of conformity between the actual processing result and the expected processing result in the time dimension, that is, a degree of conformity between a data transmission/reception time and an expected processing duration.

More details about the data transmission/reception time and the expected processing duration may be found in FIG. 2.

In some embodiments, the processing confidence level may be represented by a value between 0 and 1. A larger value indicates a higher processing confidence level, meaning a higher degree of conformity between the actual processing result of the platform and the expected processing result of the platform.

In some embodiments, the processor may determine the processing confidence level of the target platform based on the communication features and the monitoring data in various ways. For example, for monitoring data processed by one target platform, the processor may determine a deviation threshold for the monitoring data based on its data importance and the transmission priority in the communication features; determine a processing confidence level corresponding to a target platform processing that monitoring data based on the deviation threshold and a time deviation; and determine the processing confidence level of the target platform as a statistical value (such as mean, mode, etc.) of a plurality of processing confidence levels corresponding to a plurality of pieces of monitoring data processed by the target platform.

Merely by way of example, for monitoring data W₁ processed by a target platform B, its deviation threshold may be determined by the following formula (1):

$${K}_{1} = M \div ( {w}_{1} \times {P}_{1} + {w}_{2} \times {F}_{1} ) \qquad ( 1 )$$

Where, W₁ and W₂ are order-of-magnitude constants, K₁ is a deviation threshold of the monitoring data W₁, M is a base deviation threshold, P₁ is the data importance of the monitoring data W₁, F₁ is the transmission priority of the monitoring data W₁. The order-of-magnitude constants and the base deviation threshold may be set by the processor by default or by a technician based on experience.

Merely by way of example, the processing confidence level corresponding to the target platform B processing the monitoring data W₁ may be determined by the following formula (2):

$${R}_{1} = ( {K}_{1} - {T}_{1} ) \div {K}_{1} \qquad ( 2 )$$

Where, R₁ is a processing confidence level of the monitoring data W₁, K₁ is a deviation threshold of the monitoring data W₁, T₁ is the time deviation.

Correspondingly, if the monitoring data processed by the target platform B includes the monitoring data W₁, monitoring data W₂, and monitoring data W₃, with corresponding processing confidence levels R₁, R₂, R₃ respectively, then the processing confidence level of the target platform B may be

$$\frac{{R}_{1} + {R}_{2} + {R}_{3}}{3} .$$

More details about the communication data, the transmission priority, the deviation threshold, the time deviation, may be found in FIG. 2.

In some embodiments, the processor may also obtain processing flow data of the monitoring data; and determine the processing confidence level corresponding to the monitoring data at the target platform based on the monitoring data, the processing flow data, and the communication features.

More details about the monitoring data, the communication features, the processing confidence level may be found in relevant descriptions above.

The processing flow data refers to relevant data involved in the data processing flow. In some embodiments, the processing flow data may include data change information for one or more processing stages and the one or more target platforms performing the processing.

The processing stage refers to each stage where the monitoring data is processed, such as, a forwarding stage, a computing stage, a storage stage, etc. In some embodiments, the processing stage may be represented by the target platform where the monitoring data is processed, i.e., one processing stage corresponds to one target platform.

The data change information refers to data that may characterize changes in the monitoring data. In some embodiments, the data change information may include input data and output data of the monitoring data at the target platform. If the monitoring data is stored at the target platform, i.e., the storage stage of the monitoring data, the corresponding data change information may only include the input data of the monitoring data at that target platform.

For example, for the monitoring data W₁, processing stage 1 is the forwarding stage, corresponding target platform is B₁. After the forwarding stage, the monitoring data W₁ remains unchanged, the data change information is (W₁, W₁); processing stage 2 is the computing stage, corresponding target platform is B₂. After the computing stage, the monitoring data W₁ transforms into the monitoring data W₂, data change information is (W₁, W₂); processing stage 3 is the storage stage, corresponding target platform is B₃. After the storage stage, the monitoring data W₂ remains unchanged and is not output, data change information is (W₂). In summary, the processing flow data of the monitoring data {B₁(W₁, W₁), B₂(W₁, W₂), B₃(W₂)}.

In some embodiments, the processor may read the data change information for each processing stage obtained from a target platform corresponding to each processing stage of the monitoring data, thereby obtaining the processing flow data of the monitoring data.

In some embodiments, the processing confidence level corresponding to the monitoring data at the target platform may refer to a degree of conformity between the data transmission/reception time and the expected processing duration for that monitoring data on that target platform.

In some embodiments, the processor may determine the processing confidence level corresponding to the monitoring data at the target platform based on the monitoring data, the processing flow data of the monitoring data, and the communication features of the target platform in various ways. For example, the processor may determine the processing confidence level by querying a first vector database.

The first vector database may include a plurality of first standard vectors and corresponding first vector labels. In some embodiments, the first vector database may be constructed by the processor or technicians based on historical data. The processor may construct a plurality of first candidate vectors based on a large amount of historical data. The first candidate vector consists of historical monitoring data, historical processing flow data of that historical monitoring data, historical communication features of a historical target platform, and an actual processing confidence level corresponding to the historical monitoring data at the historical target platform. The processor may cluster the plurality of first candidate vectors to form a plurality of first cluster centers, construct the first standard vector from the historical monitoring data, its historical processing flow data, and the historical communication features of the historical target platform corresponding to the first cluster center, determine the actual processing confidence level corresponding to the first cluster center as the first vector label of the first standard vector. Clustering manners may include, but are not limited to, K-means clustering, mean-shift clustering, etc.

In some embodiments, the actual processing confidence level may be determined based on a platform same-type fault frequency and a data fault frequency. The platform same-type fault frequency refers to a count of times the same fault type occurs on the same platform within a preset time. The data fault frequency refers to a ratio of a count of target platforms where the monitoring data was located when a fault occurred to a total count of platforms the monitoring data passed through, within the preset time. The preset time may be set by the processor by default or preset by a technician.

Merely by way of example, the actual processing confidence level

$${R}_{11}^{*}$$

corresponding to historical monitoring data

$${W}_{1}^{*}$$

at historical target platform B₁^{*} may be determined by the following formula (3):

$${R}_{11}^{*} = {w}_{3} \times \frac{1}{S + a} + {w}_{4} \times \frac{1}{D + β} \qquad ( 3 )$$

Where, w₃ and w₄ are the order-of-magnitude constants, α and β are decimals approaching 0, configured to prevent division by zero, S represents the platform same-type fault frequency, D represents the data fault frequency. w₃, w₄, α, and β are all set by the processor by default or preset by a technician.

In some embodiments, the processor may construct a first vector to be matched based on a current piece of monitoring data, its processing flow data, and the communication features of a target platform, determine a plurality of first similarities between the first vector to be matched and the plurality of first standard vectors in the first vector database, determine the first vector label corresponding to the first standard vector with the highest first similarity as the processing confidence level corresponding to the monitoring data at the target platform. The first similarity may be Euclidean distance, cosine similarity, Jaccard similarity, etc.

In some embodiments, the processing confidence level corresponding to the monitoring data at the target platform is further related to a processing flexibility level of a supervision object.

The processing flexibility level refers to a degree of flexibility in processing the supervision object. In some embodiments, the processing flexibility level may be represented by a value from 1 to 10. A larger value indicates a higher processing flexibility level.

A supervision plan refers to a relevant plan for supervising the gas pipeline network. In some embodiments, the supervision plan may include a supervision intensity of the supervision object.

The supervision intensity refers to an intensity of supervision over the supervision object. In some embodiments, the supervision intensity of the supervision object may be characterized by the monitoring frequency of the supervision object. A higher monitoring frequency indicates a greater supervision intensity.

The monitoring frequency refers to a count of times the supervision object is monitored per unit time.

In some embodiments, the processor may obtain the supervision plan of the gas pipeline network in various ways. For example, the processor may directly retrieve a manually pre-uploaded supervision plan.

In some embodiments, the processor may determine the processing flexibility level of the supervision object based on the supervision plan of the gas pipeline network in various ways. For example, the processing flexibility level of the supervision object may be negatively correlated with the supervision intensity of the supervision object.

In some embodiments, the processing confidence level corresponding to the monitoring data at the target platform may be positively correlated with the processing flexibility level of the supervision object.

In some embodiments of the present disclosure, based on the supervision plan of the gas pipeline network, the processing flexibility level of the supervision object can be accurately determined. Correlating the processing confidence level with the processing flexibility level can reduce misjudgments or missed judgments caused by overly strict confidence levels, thereby improving overall processing efficiency and accuracy.

In some embodiments of the present disclosure, by recording and analyzing the processing flow data, every stage from data collection to the final processing result can be clearly understood, improving the transparency of the entire process and enhancing the traceability of the system. The processing confidence level derived from comprehensive consideration of processing flow data and communication features provides more precise data support. At the same time, by considering potential differences in different processing stages and possible changes during communication, the reliability of the processing confidence level is increased.

In some embodiments, the processor may determine the platform fault data based on the processing confidence level and the communication features of the target platform in various ways. For example, the processor may determine the platform fault data by querying a second vector database based on the processing confidence level and the communication features.

The second vector database may include a plurality of second standard vectors and corresponding second vector labels. In some embodiments, the second vector database may be constructed by the processor or technicians based on historical data. The processor may construct a plurality of second candidate vectors based on a large amount of historical data. The second candidate vector consists of historical communication features and a historical processing confidence level of a historical target platform, and actual historical platform fault data corresponding to the historical target platform.

The processor may cluster the plurality of second candidate vectors to form a plurality of second cluster centers, construct the second standard vector from the historical communication features and the historical processing confidence level of the historical target platform corresponding to the second cluster center, and determine the actual historical platform fault data corresponding to that second cluster center as the second vector label of that second standard vector.

The processor may directly determine the actual historical platform fault data based on the historical data. Clustering manners may include, but are not limited to, the K-means clustering, the mean-shift clustering, etc.

In some embodiments, the processor may construct a second vector to be matched based on current communication features and the processing confidence level, determine a plurality of second similarities between the second vector to be matched and the plurality of second standard vectors in the second vector database, determine the second vector label corresponding to the second standard vector with the highest second similarity as current platform fault data. The second similarity may be Euclidean distance, cosine similarity, etc.

In some embodiments, as shown in FIG. 3, the processor may determine platform fault data 350 through a fault prediction model 340 based on the processing confidence level 330 and the communication features 310 of the one or more target platforms.

More details about the processing confidence level, the communication features, the platform fault data may be found in FIG. 2.

The fault prediction model refers to a model configured to determine the platform fault data. In some embodiments, the fault prediction model may be a machine learning model, such as a Neural Network (NN) model or any other custom model structure, or a combination thereof.

In some embodiments, an input of the fault prediction model 340 may include the processing confidence level 330 and the communication features 310, and an output of the fault prediction model 340 may include the platform fault data 350.

In some embodiments, the fault prediction model may be trained and obtained in various ways. For example, the fault prediction model may be trained using a plurality of first training samples with first training labels. A set of first training sample may include sample processing confidence levels and sample communication features of one or more sample target platforms. The first training label corresponding to the first training sample may be actual platform fault data. The first training samples and the first training labels may be obtained based on historical data.

In some embodiments, the processor may train and obtain the fault prediction model based on the first training samples and the first training labels. Training manners may include, but are not limited to, gradient descent. Merely by way of example, the processor may input the plurality of first training samples with the first training labels into an initial fault prediction model, construct a first loss function based on the first training labels and the output results of the initial fault prediction model, and iteratively update parameters of the initial fault prediction model based on the first loss function. The model training is completed when a first preset condition is met, resulting in the trained fault prediction model. The first preset condition may be that the first loss function converges, a count of iterations reaches a threshold, etc.

In some embodiments of the present disclosure, by using the fault prediction model to determine the platform fault data, the data processing capability and data analysis capability of the model can be fully utilized to obtain accurate and reliable platform fault data in a short time, thereby improving efficiency and accuracy.

In some embodiments of the present disclosure, by comprehensively considering the data importance of the monitoring data and the transmission priority, the calculated processing confidence level can more accurately reflect the degree of conformity between the actual processing result and the expected processing result. By setting the processing confidence level, the effectiveness of the platform's data processing can be quantified, helping to more precisely evaluate the platform's performance. Based on the processing confidence level and communication features, the accuracy of platform fault data can be improved to ensure the accuracy and efficiency of fault handling and reduce misjudgments and repetitive work.

FIG. 4 is an exemplary schematic diagram of determining a fault handling parameter according to some embodiments of the present disclosure.

In some embodiments, as shown in FIG. 4, the processor may determine a fault importance level 430 of the fault based on the platform fault data 350 within a first preset period; and determine the fault handling parameter 460 based on the fault importance level 430.

More details about the first preset period, the fault handling parameter, the platform fault data may be found in FIG. 2.

The first preset period may be a current first preset period. The current first preset period refers to a first preset period in which the current time is located.

The fault importance level may be used to measure the extent of loss caused by the fault. In some embodiments, the fault importance level may be represented by a value from 1 to 10. A higher value indicates higher fault importance and greater loss caused by the fault.

In some embodiments, the processor may determine the fault importance level based on the platform fault data within the current first preset period in various ways. For example, the processor may determine the fault importance level by querying a third preset table based on the platform fault data within the current first preset period. The third preset table includes a plurality of sample platform fault data and corresponding sample fault importance levels.

In some embodiments, the third preset table may be constructed based on historical data. For example, the processor may use historical platform fault data where faults occurred historically but were not resolved in time as the sample platform fault data, and use the historical fault importance level corresponding to the sample platform fault data as the sample label. The processor and/or technicians may evaluate and determine the historical fault importance level based on the historical actual loss corresponding to the sample platform fault data, and annotate as the sample label. The greater the historical actual loss, the higher the historical fault importance level.

In some embodiments, the processor may determine the fault importance level by querying the third preset table based on the platform fault data within the current first preset period. For example, calculate a plurality of third similarities between the platform fault data within the current first preset period and the plurality of sample platform fault data in the third preset table, use the sample label corresponding to the sample platform fault data with the highest third similarity as the fault importance level of the platform fault data within the current first preset period. The third similarity may be Euclidean distance, cosine similarity, or a combination thereof.

In some embodiments, as shown in FIG. 4, the processor may also determine the fault importance level 430 through an importance prediction model 420 based on the platform fault data 350 for one or more second preset periods within the first preset period. More details about the second preset period may be found in FIG. 2.

The importance prediction model refers to a model configured to determine the fault importance level. In some embodiments, the importance prediction model may be a machine learning model, such as a Neural Network (NN) model, etc.

In some embodiments, an input of the importance prediction model 420 includes the platform fault data 350 for one or more second preset periods within the first preset period, and an output of the importance prediction model 420 includes the fault importance level 430.

In some embodiments, the importance prediction model may be trained and obtained in various ways. For example, the importance prediction model may be trained using a plurality of second training samples with second training labels. The second training samples may include platform fault data during one or more second preset periods within the first preset period.

In some embodiments, the second training samples and the second training labels may be obtained based on historical data. The second training sample is historical platform fault data during one or more historical second preset periods within a historical first preset period. The second training label corresponding to the second training sample is the actual historical fault importance level. The acquisition and annotation of the second training label are similar to the sample labels of the third preset table, which will not be repeated here.

In some embodiments, the processor may train and obtain the importance prediction model based on the second training samples and the second training labels. For the training process of the importance prediction model, refer to the relevant description of the training process of the fault prediction model in FIG. 3; the processes are similar and will not be repeated here.

In some embodiments, as shown in FIG. 4, the input of the importance prediction model 420 may further include a supervision plan 410 of the gas pipeline network.

More details on the supervision plan may be found in FIG. 2.

In some embodiments, the second training samples of the importance prediction model may further include a sample supervision plan of a sample gas pipeline network. The sample supervision plan may be obtained based on historical data.

In some embodiments, the processor may train and obtain the importance prediction model based on second training samples including the sample platform fault data and the sample supervision plan, and the corresponding second training labels.

For the training manner of the importance prediction model, see the relevant descriptions above.

In some embodiments of the present disclosure, by including the supervision plan as input to the importance prediction model, the influence of the supervision plan on the fault importance level can be effectively considered, making the prediction of the fault importance level more accurate.

In some embodiments of the present disclosure, by using the importance prediction model to determine the fault importance level, the data processing capability and data analysis capability of the model can be fully utilized to obtain an accurate and reliable fault importance level in a short time, thereby improving efficiency and accuracy.

In some embodiments, the processor may determine the fault handling parameter based on the fault importance level in various ways. For example, the processor may determine the fault handling parameter corresponding to the fault importance level by querying a fourth preset table. The fourth preset table may be constructed based on historical data. The fourth preset table may include a plurality of historical fault importance levels and corresponding historical fault handling parameters.

In some embodiments, as shown in FIG. 4, the processor may determine that the fault is a current batch fault 450 based on the fault importance level 430 and a preset threshold 440; and determine the fault handling parameter 460 based on the platform fault data corresponding to the current batch fault 450.

More details on the fault importance level, the platform fault data, and the fault handling parameter may be found in the corresponding descriptions above.

The preset threshold refers to a preset minimum value of the fault importance level for the current batch fault, such as 0.6, etc.

The current batch fault refers to a fault that needs to be processed in the current batch.

In some embodiments, the processor may determine faults with the fault importance level not less than the preset threshold as the current batch fault.

In some embodiments, the preset threshold may be positively correlated with fault handling cost. The higher the fault handling cost, the greater the loss caused by the fault, and the higher the cost-benefit ratio of handling the fault, the larger the preset threshold.

The fault handling cost refers to the cost required to repair a fault. In some embodiments, the fault handling cost may be represented by a time consumed to handle the fault, a count of personnel involved, and a count of devices involved. The longer the time consumed and the greater the count of personnel and devices involved, the higher the fault handling cost. In some embodiments, the processor may calculate an average value of a plurality of historical fault handling costs corresponding to a plurality of historical faults and determine the average value as the fault handling cost.

In some embodiments, the preset threshold may also be related to a dispersion degree of the processing confidence level of the monitoring data. The preset threshold may be negatively correlated with the dispersion degree of the processing confidence level. The greater the dispersion degree, the greater the fluctuation in the processing quality of monitoring data, and the greater the potential risk in the gas pipeline network. To group more faults in the current batch for joint processing, a small preset threshold needs to be set.

The dispersion degree of the processing confidence level of the monitoring data may be represented by a variance of the processing confidence levels corresponding to a plurality of pieces of monitoring data. A larger variance indicates a greater dispersion degree.

In some embodiments, the processor may determine the fault handling parameter based on the platform fault data corresponding to the current batch fault in various ways. For example, the processor may determine a fault frequency distribution based on the platform fault data corresponding to the current batch fault; and determine the fault handling parameter based on the fault frequency distribution. For more details on this part, refer to the relevant description of step 222-1 in FIG. 2; the process is similar and will not be repeated here.

In some embodiments of the present disclosure, by comparing the fault importance level and the preset threshold to quickly distinguish whether the fault is the current batch fault, faults with high importance can be screened out and handled promptly. This effectively improves the efficiency of handling important faults and the rationality of fault management, and reduces losses to the system caused by untimely handling of important faults.

In some embodiments of the present disclosure, by accurately assessing the importance level of a fault based on the platform fault data, a reasonable fault handling parameter is determined through the fault importance level. This facilitates the rational allocation of resources and time, thereby enhancing the overall stability and operational benefits of the system.

One or more embodiments of the present disclosure provide a non-transitory computer-readable storage medium. The storage medium stores computer instructions. When a computer reads the computer instructions in the storage medium, the computer executes the method for smart gas pipeline network fault safety handling.

Certain features, structures, or characteristics in one or more embodiments of the present disclosure may be appropriately combined.

Furthermore, unless explicitly stated in the claims, the order and sequences of processing elements, the use of numerical and alphabetic characters, or the use of other names in the present disclosure are not intended to limit the sequence of the processes and methods described herein. While various examples have been discussed in the present disclosure to illustrate certain inventive embodiments that are currently considered useful, it should be understood that such details are provided for illustrative purposes and that the appended claims are not limited to the disclosed embodiments. Instead, the claims are intended to cover all modifications and equivalent combinations that fall within the spirit and scope of the embodiments described in the present disclosure. For example, while the system components described above may be implemented through hardware devices, they may also be achieved solely through software solutions, such as by installing the described system on existing servers or mobile devices.

If there is any inconsistency or conflict between the descriptions, definitions, and/or use of terms in the materials cited in the present disclosure and the content described in the present disclosure, the descriptions, definitions, and/or use of terms in the present disclosure shall prevail.

What is claimed is:

1. An internet of things (IoT) system for smart gas pipeline network fault safety handling, wherein the IoT system comprises: a government safety supervision service platform; a government safety supervision management platform; a government safety supervision sensing network platform; a government safety supervision object platform; a gas company sensing network platform; a smart gas device object platform; and a gas maintenance object platform; wherein,
the government safety supervision object platform includes a gas company management platform and key gas-consuming enterprises; the smart gas device object platform at least includes monitoring devices and a gas regulation device deployed in a gas pipeline network; the monitoring devices are configured to monitor the gas pipeline network;
the gas maintenance object platform at least includes personnel interaction devices;
the government safety supervision management platform is configured to:
in a first preset period,
obtain platform fault data within the first preset period, wherein the platform fault data includes a faulty platform and/or a fault type occurring on the faulty platform;
for platform fault data of which a fault type is unknown:
in response to determining that a data volume is greater than a preset volume, determine a gas adjustment parameter and send the gas adjustment parameter to the gas regulation device;
in response to determining that the data volume is less than the preset volume:
determine a fault handling parameter based on the platform fault data within the first preset period; and
generate an adjustment instruction based on the fault handling parameter, and send the adjustment instruction to one or more of the monitoring devices to adjust monitoring parameters of the one or more of the monitoring devices, and/or send the adjustment instruction to one or more target platforms to adjust communication parameters of the one or more target platforms, and/or send the adjustment instruction to one or more of the personnel interaction devices to adjust on-site personnel arrangement;
wherein, the first preset period includes one or more second preset periods; the government safety supervision management platform is further configured to:
periodically obtain the platform fault data during the one or more second preset periods within the first preset period according to the one or more second preset periods;
in each of the one or more second preset periods,
obtain monitoring data of the monitoring devices;
obtain communication features of the one or more target platforms; and
determine the platform fault data based on the communication features and the monitoring data.

2. The IoT system according to claim 1, wherein a period length of the first preset period is related to a fault response speed; and a period length of the second preset period is related to a complexity level of the gas pipeline network.

3. The IoT system according to claim 1, wherein the monitoring data further includes a data importance, and the government safety supervision management platform is further configured to:
determine a processing confidence level of the one or more target platforms based on the communication features and the monitoring data; and
determine the platform fault data based on the processing confidence level and the communication features of the one or more target platforms.

4. The IoT system according to claim 3, wherein the government safety supervision management platform is further configured to:
determine the platform fault data by a fault prediction model based on the processing confidence level and the communication features of the one or more target platforms, the fault prediction model being a machine learning model.

5. The IoT system according to claim 3, wherein the government safety supervision management platform is further configured to:
obtain processing flow data of the monitoring data, wherein the processing flow data includes data change information for one or more processing stages and the one or more target platforms performing processing; and
determine the processing confidence level corresponding to the monitoring data at the one or more target platforms based on the monitoring data, the processing flow data, and the communication features.

6. The IoT system according to claim 5, wherein the processing confidence level corresponding to the monitoring data at the one or more target platforms is further related to a processing flexibility level of a supervision object, and the government safety supervision management platform is further configured to:
determine the processing flexibility level of the supervision object based on a supervision plan of the gas pipeline network, the supervision plan including a supervision intensity of the supervision object.

7. The IoT system according to claim 1, wherein the government safety supervision management platform is further configured to:
determine a fault importance level of a fault based on the platform fault data within the first preset period; and
determine the fault handling parameter based on the fault importance level.

8. The IoT system according to claim 7, wherein the government safety supervision management platform is further configured to:
in response to determining that the fault importance level is not less than a preset threshold, determine the fault is a current batch fault, the preset threshold being related to a dispersion degree of the processing confidence level of the monitoring data; and
determine the fault handling parameter based on the platform fault data corresponding to the current batch fault.

9. The IoT system according to claim 7, wherein the government safety supervision management platform is further configured to:
determine the fault importance level by an importance prediction model based on the platform fault data during the one or more second preset periods within the first preset period, the importance prediction model being a machine learning model.

10. The IoT system according to claim 9, wherein an input of the importance prediction model further includes a supervision plan of the gas pipeline network.

11. A method for smart gas pipeline network fault safety handling, wherein the method is implemented based on an internet of things (IoT) system for smart gas pipeline network fault safety handling, and the IoT system includes: a government safety supervision service platform; a government safety supervision management platform; a government safety supervision sensing network platform; a government safety supervision object platform; a gas company sensing network platform; a smart gas device object platform; and a gas maintenance object platform;
wherein the method is executed by the government safety supervision management platform, and the method comprises:
in a first preset period:
obtaining platform fault data within the first preset period, wherein the platform fault data includes a faulty platform and/or a fault type occurring on the faulty platform;
for platform fault data of which a fault type is unknown:
in response to determining that a data volume is greater than a preset volume, determining a gas adjustment parameter and sending the gas adjustment parameter to the gas regulation device;
in response to determining that the data volume is less than the preset volume:
determining a fault handling parameter based on the platform fault data within the first preset period; and
generating an adjustment instruction based on the fault handling parameter, and sending the adjustment instruction to one or more of the monitoring devices to adjust monitoring parameters of the one or more of the monitoring devices, and/or sending the adjustment instruction to one or more target platforms to adjust communication parameters of the one or more target platforms, and/or sending the adjustment instruction to one or more of the personnel interaction devices to adjust on-site personnel arrangement;
wherein, the first preset period includes one or more second preset periods, and the obtaining the platform fault data within the first preset period includes:
periodically obtaining the platform fault data during the one or more second preset periods within the first preset period according to the one or more second preset periods;
in each of the one or more second preset periods,
obtaining monitoring data of the monitoring devices;
obtaining communication features of the one or more target platforms; and
determining the platform fault data based on the communication features and the monitoring data.

12. The method according to claim 11, wherein a period length of the first preset period is related to a fault response speed; and a period length of the second preset period is related to a complexity level of the gas pipeline network.

13. The method according to claim 11, wherein the monitoring data further includes a data importance, and the determining the platform fault data based on the communication features and the monitoring data includes:
determining a processing confidence level of the one or more target platforms based on the communication features and the monitoring data; and
determining the platform fault data based on the processing confidence level and the communication features of the one or more target platforms.

14. The method according to claim 13, wherein the determining the platform fault data based on the processing confidence level and the communication features of the one or more target platforms includes:
determining the platform fault data by a fault prediction model based on the processing confidence level and the communication features of the one or more target platforms, the fault prediction model being a machine learning model.

15. The method according to claim 13, wherein the determining the processing confidence level of the one or more target platforms based on the communication features and the monitoring data includes:
obtaining processing flow data of the monitoring data, wherein the processing flow data includes data change information for one or more processing stages and the one or more target platforms performing processing; and
determining the processing confidence level corresponding to the monitoring data at the one or more target platforms based on the monitoring data, the processing flow data, and the communication features.

16. The method according to claim 15, wherein the processing confidence level corresponding to the monitoring data at the one or more target platforms is further related to a processing flexibility level of a supervision object, and the method further comprises:
determining the processing flexibility level of the supervision object based on a supervision plan of the gas pipeline network, the supervision plan including a supervision intensity of the supervision object.

17. The method according to claim 11, the determining the fault handling parameter based on the platform fault data within the first preset period includes:
determining a fault importance level of a fault based on the platform fault data within the first preset period; and
determining the fault handling parameter based on the fault importance level.

18. The method according to claim 17, the determining the fault importance level of the fault based on the platform fault data within the first preset period includes:
determining the fault importance level by an importance prediction model based on the platform fault data during the one or more second preset periods within the first preset period, the importance prediction model being a machine learning model.

19. The method according to claim 18, wherein an input of the importance prediction model further includes a supervision plan of the gas pipeline network.

20. A non-transitory computer-readable storage medium, wherein the storage medium stores computer instructions, and when a computer reads the computer instructions in the storage medium, the computer executes the method for smart gas pipeline network fault safety handling of claim 11.
